(19) United States
(12) Patent Application Publication
(10) Pub. No.: US 2022/0234070 A1
(43) Pub. Date: Jul. 28, 2022

(54) DEPOSITION METHOD

(71) Applicant: Commissariat à I'Énergie Atomique et aux Énergies Alternatives, Paris (FR)

(72) Inventor: Bernard Viala, Grenoble (FR)

(73) Assignee: Commissariat à I'Énergie Atomique et aux Énergies Alternatives, Paris (FR)

(21) Appl. No.: 17/617,569

(22) PCT Filed: Jun. 8, 2020
(86) PCT No.: PCT/EP2020/065874

§ 371 Date: Dec. 8, 2021

(30) Foreign Application Priority Data
Jun. 11, 2019 (FR) FR1906194

(51) Int. Cl. B05D 1/00

(52) U.S. Cl. CPC B05D 1/005

(57) ABSTRACT

A method for depositing a layer of a nanocomposite material comprising the step of pouring said liquid material onto the surface of a substrate, said substrate being subjected to an oscillating rotary motion.

The present patent application claims the priority of the French patent application FR19/06194 which will be considered as an integral part of the present description.

### TECHNICAL FIELD

The present disclosure relates generally to deposition techniques and, more particularly, to methods for coating substrates with materials containing nanoparticles, called nanocomposite materials.

### BACKGROUND ART

Methods for spin coating resins are known. These spin coating methods are widely used in microelectronics, in particular to deposit resin layers on substrates. The layers thus obtained generally have satisfactory characteristics (thickness, homogeneity, continuity, roughness, etc.), provided that the resin of which they are made is of a simple chemical composition. It is also often preferable for the substrate to be circular in shape (for example, a silicon wafer).

One disadvantage of spin coating methods is that they cause significant loss of material. Because the substrate is often driven at high rotational speeds, a large amount of resin is ejected from the substrate due to the centrifugal force. Another disadvantage of these spin coating methods is that they are furthermore very difficult to implement for deposits of nanocomposite materials, i.e. materials containing nanoparticles.

Yet another disadvantage of spin coating methods with materials containing nanoparticles is that they do not make it possible to obtain a layer thickness greater than a few micrometers, in a single deposit. Indeed, a nanocomposite solution is a colloid (with a fraction of polymer added) that must remain fluid to be able to put into and jeep the nanoparticles in suspension. Such a solution therefore has a significantly lower viscosity than traditional resins (up to fifty times lower). For identical deposition conditions, the thickness obtained from a nanocomposite solution will therefore be smaller than that obtained from a traditional resin.

For example, a nanocomposite solution with polystyrene and cobalt nanoparticles has a maximum viscosity of the order of a few tens of centistokes (cSt). For a rotation speed of 2000 rpm, with a viscosity of 20 cSt, the thickness obtained is of the order of 0.4 μm. In comparison, with a microelectronics resin that can have a much higher viscosity, such as 1025 cSt (MicroChem SU-8 2015), the thickness obtained at 2000 rpm is of the order of 20 μm.

### SUMMARY OF INVENTION

There is a need to improve known spin coating methods.

One embodiment addresses all or some of the drawbacks of known coating methods.

One embodiment provides a method for depositing a layer of a composite material, comprising the step of pouring said material, in the liquid state, onto the surface of a substrate subjected to an oscillating movement, taking place in a plane substantially parallel to the surface of the substrate on which the deposition of the layer is performed and around an axis of rotation perpendicular to the substrate, wherein:
the material comprises a liquid polymer having nanoparticles dispersed therein; and
the layer has a thickness of between about 10 μm and about 1 mm, preferably between 10 μm and 500 μm, more preferably between 20 μm and 300 μm.

According to one embodiment, said substrate is subjected to oscillatory motion during pouring.

According to one embodiment, said substrate is subjected to the oscillating motion after pouring.

According to one embodiment, the nanoparticles are magnetic nanoparticles.

According to one embodiment, the thickness of the layer is based on the amount of material poured.

According to one embodiment, the uniformity of the thickness of the layer across the surface of the substrate is based on the amplitude of the oscillating motion.

According to one embodiment, the oscillating motion amplitude is between about 5° and about 180°, preferably between 20° and 120°, more preferably between 30° and 90°.

According to one embodiment, the oscillating motion is performed at an acceleration of between about 0.1 rad·s⁻² and about 3,000 rad·s⁻², preferably between about 100 rad·s⁻² and about 2,000 rad·s⁻², more preferably about 2,000 rad·s⁻².

According to one embodiment, the substrate is circular in shape.

According to one embodiment, the substrate is polygonal in shape, preferably rectangular or square in shape.

According to one embodiment, the substrate is made of semiconductor material, ceramic, glass, plastic material or metal, preferably silicon.

According to one embodiment, the oscillating motion is imposed on the substrate by spin coating equipment.

According to one embodiment, the substrate carries at least one conductive element for forming a capacitance or inductive winding for forming an inductance, a transmission line or an antenna, encapsulated by the layer covering the substrate.

One embodiment provides an electronic device having at least one layer deposited by the method as described.

### BRIEF DESCRIPTION OF DRAWINGS

The foregoing features and advantages, as well as others, will be described in detail in the following description of specific embodiments given by way of illustration and not limitation with reference to the accompanying drawings, in which:

FIG. 1 shows schematically an example spin coating method, in perspective views A, B and C;

FIG. 2 shows schematically a coating equipment embodiment;

FIG. 3 shows, viewed from above, a method for implementing a coating method using deposition equipment of the type described in relation to FIG. 2;

FIG. 4 shows schematically a side and cross-sectional view of one embodiment of a layer deposited by the coating method described in relation to FIG. 3;

FIG. 5 is a characteristic graph of layers obtained by the implementation of the method set out in relation to FIG. 3; and

FIG. 6 is another characteristic graph of layers obtained by the implementation of the method out in relation to FIG. 3.

### DESCRIPTION OF EMBODIMENTS

Like features have been designated by like references in the various figures. In particular, the structural and/or functional features that are common among the various embodiments may have the same references and may dispose identical structural, dimensional and material properties.

For the sake of clarity, only the operations and elements that are useful for an understanding of the embodiments described herein have been illustrated and described in detail. In particular, the polymer and nanoparticle synthesis methods are not described, as the described embodiments and implementation methods are compatible with the usual polymer synthesis methods and nanoparticle synthesis methods. Similarly, the methods for manufacturing the substrates on whose surfaces the deposits are made are not described, the embodiments and implementation methods described being compatible with usual substrate manufacturing methods.

Unless indicated otherwise, when reference is made to two elements connected together, this signifies a direct connection without any intermediate elements other than conductors, and when reference is made to two elements coupled together, this signifies that these two elements can be connected or they can be coupled via one or more other elements.

In the following disclosure, unless indicated otherwise, when reference is made to absolute positional qualifiers, such as the terms “front”, “back”, “top”, “bottom”, “left”, “right”, etc., or to relative positional qualifiers, such as the terms “above”, “below”, “higher”, “lower”, etc., or to qualifiers of orientation, such as “horizontal”, “vertical”, etc., reference is made to the orientation shown in the figures, as orientated during normal use.

Unless specified otherwise, the expressions “around,” “approximately,” “substantially,” and “in the order of” signify within 10% or 1°, preferably to within 5% or 0.5°.

Nanoparticle generally means any object comprising a preferably regular assembly of atoms, at least one of whose dimensions is nanometric, i.e. typically less than about one hundred nanometers, for example between two and one hundred nanometers. In particular, in the following description, a nanoparticle is considered any object selected from:

a nanograin of a spherical, ovoid or polyhedral shape;

a nanotube; and

a nanowire; and

a nanosheet, i.e. a planar assembly of atoms having a nanometric thickness.

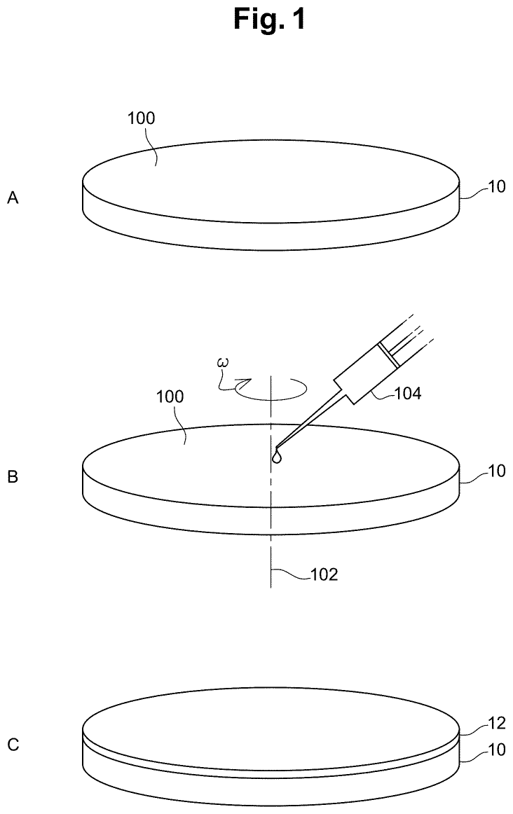

FIG. 1 shows schematically, in perspective views A, B and C, an example of a spin coating method.

Spin coating is a technique frequently used in microelectronics. In particular, this technique is often used to deposit a layer of resin such as a resin used in photolithography (photoresist), on a circular substrate such as a silicon wafer.

In the example of the spin coating method shown in FIG. 1, (in view A) a substrate 10 is first provided on the surface of which a deposit is desired. In the example shown in FIG. 1, the substrate 10 is a silicon wafer having a circular shape when viewed from above. It is assumed, again in this example, that it is desired to deposit a resin layer on a surface 100 of the wafer 10 (the top surface, in FIG. 1).

The wafer 10 is then rotated generally about an axis 102 (view B) passing perpendicularly through the top surface 100 of the wafer 10 at its center or middle. In the example shown in FIG. 1, the wafer 10 is rotated about the axis 102, in a clockwise direction as viewed from above, at an angular velocity noted as ω. The angular velocity is held substantially constant at a first value, noted ωs, of about 500 rpm⁻¹, for example.

An operation is then performed consisting of dispensing or causing one or more drops of a solution containing the resin to be deposited to fall approximately in the middle or center of the surface 100 of the wafer 10. This operation is performed with a syringe 104, in the example shown in FIG. 1. However, the syringe 104 can be replaced by a pipette, a ProPipette equipped with a suitable tip, etc., particularly when the deposited solution has a high viscosity.

In this example, the angular velocity is considered to be non-zero (ωs>0 rpm⁻¹) at the time of deposition of the solution drop or drops on the surface 100 of the wafer 10. The rotation of the wafer 10 around the axis 102, under the effect of centrifugal forces, then causes a spreading of the solution on the surface 100. The resin contained in the solution is thus distributed substantially homogeneously over the surface 100 of the wafer 10.

Then, the angular speed w of rotation of the wafer 10 is gradually increased to a second value, noted ωf, greater than the first value ωs. The second value ωf is about 2000 rpm⁻¹, for example. In other words, the rotation of the wafer 10 is accelerated. The acceleration imparted to the wafer 10, after depositing the drop(s) of solution on its top surface 100, is adjusted generally based on an evaporation rate of a solvent contained in that solution.

In some applications, the wafer 10 remains stationary while the solution is dispensed onto its surface 100. In other words, the wafer 10 does not initially rotate about the axis 102 and is driven at the speed ωs after deposition.

The acceleration, from the first value ωs to the second value ωf, of the rotation of the wafer 10 results in the removal of a significant amount of excess material. This material lost by ejection of the resin-containing solution, away from the top surface 100 of the wafer 10, cannot generally be reused for further deposition, which is a disadvantage.

A layer 12 (view C), covering the surface 100 (not visible in view C) of the wafer 10, is then obtained. The resulting layer 12 is typically a few microns thick.

The spin coating technique described above makes it possible to homogeneously coat wafers 10 up to 300 mm in diameter. In particular, spin curves are used to predict the thickness of the resin layer 12 based on the rotation speed w of the wafer 10.

Models are available to take into account various parameters (viscosity, evaporation temperature of the solvent contained in the solution, surface energy, etc.) for usual materials, of simple chemical composition. Other, more complex, models also make it possible to predict the thickness of the layer 12 for resins containing polymers of different molecular weights or mainly mineral fillers.

It might have been thought that the implementation of the spin coating technique would give satisfactory results for deposits of materials or resins containing nanoparticles, in particular magnetic nanoparticles. However, the inventors have found that resins loaded with magnetic nanoparticles form a layer 12 of composition and thickness that do not meet their expectations after spin coating deposition.

In particular, the inventors found that the nanoparticle concentration is greater in the layer 12 than in the material before deposition. The interpretation given to this phenomenon is that the resin is ejected in greater proportion than its charge, resulting in a higher final nanoparticle concentration. This preferential ejection of the resin as compared to magnetic nanoparticles seems to be due to magnetic dipolar forces acting at a distance.

In addition, the inventors found that the change in nanoparticle concentration after deposition is unpredictable. One disadvantage of the spin coating technique is therefore that its implementation is empirical, i.e. unpredictable for resin deposits loaded with magnetic nanoparticles. This leads to problems of repeatability, reliability and control, which are a major obstacle to the industrialization of the deposition of magnetic nanoparticle-loaded resins.

Another disadvantage of the spin coating technique is that it is unsuitable for depositing on polygonal-shaped substrates such as square or rectangular-shaped substrates, for which it often causes layer heterogeneities.

Another disadvantage of the spin coating technique is that it does not make it possible to obtain a layer 12 with a thickness greater than a few microns in a single operation. However, for certain applications, it would be desirable to be able to deposit layers with a greater thickness, for example of the order of a hundred microns. One could imagine repeating the method described above in relation to FIG. 1 to successively deposit several layers 12 superimposed on the surface of the substrate 10. However, particularly by producing a poor surface finish, this would be detrimental to the quality of the final deposit. Successive deposits would also take longer, which would be detrimental to industrial applications.

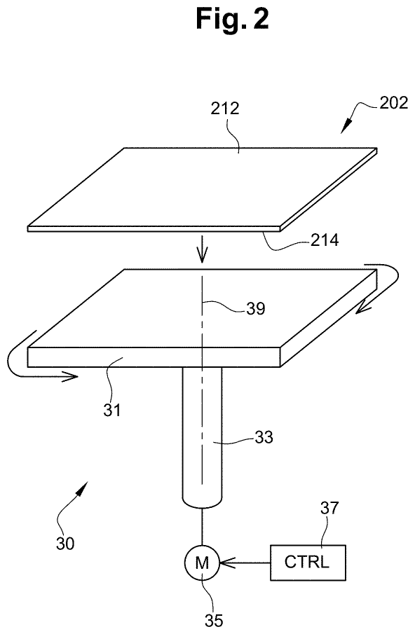

FIG. 2 shows one embodiment of deposition equipment 30, in a schematic way.

According to this embodiment, the deposition equipment 30 includes a support 31 or tray for receiving a substrate 202. The substrate 202 is held on the support 31 by a suction system (not shown), for example. In FIG. 2, the support 31 is carried by a shaft 33, such that the support 31 and the shaft 33 are coaxial. The shaft 33 is driven by a motorization 35 (M) or motor. This motorization 35 is controlled or driven by a control unit 37 (CTRL).

In the example of FIG. 2, the tray 31 has a rectangular shape. However, the shape of the tray 31 is adapted to the shape of the substrate 202 and thus may be circular.

According to the described embodiments, the control unit 37 of the deposition equipment 30 is adapted to subject the support 31, and thus the substrate 202, to an oscillating (or oscillatory) motion. This oscillating motion is performed about an axis 39, in a plane perpendicular to the shaft 33 of the equipment 30.

Assuming that a liquid material is to be deposited on a surface 212 of the substrate 202 (the top side of the substrate 202, in FIG. 2), then the substrate 202 is positioned so that it contacts the support 31 by a surface 214 (the bottom side of the substrate 202, in FIG. 2) opposite the surface 212. The oscillating movement imposed on the substrate 202 by the deposition equipment 30 is therefore performed in a plane substantially parallel to the surface 212 on which deposition is desired.

According to a preferred embodiment, the deposition equipment 30 is spinner deposition equipment.

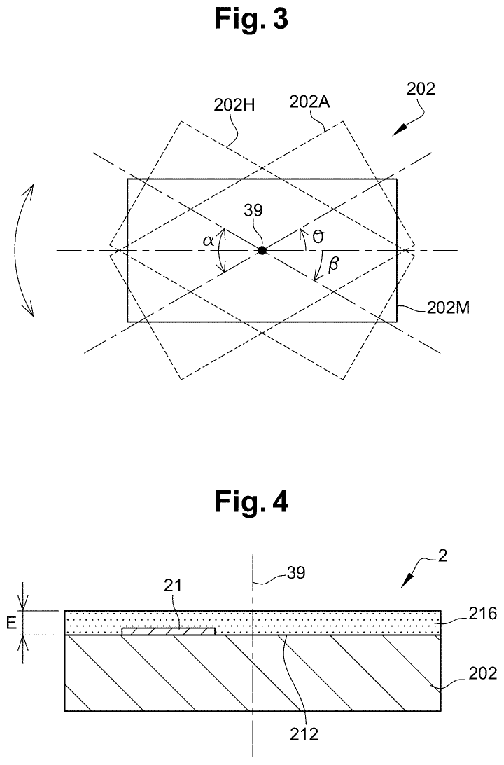

FIG. 3 shows one embodiment of a coating method using deposition equipment of the type described in relation to FIG. 2, viewed from above.

According to this embodiment, a deposition of material is carried out by pouring this material, in a liquid state, onto the surface of a substrate such as the substrate 202, subjected to an oscillating movement. This oscillating motion is imposed or imparted on the substrate 202 by deposition equipment such as the deposition equipment 30 (not shown in FIG. 3), as shown in relation to FIG. 2.

The substrate 202 oscillates about a midpoint or median position 202M in a plane perpendicular to the plane of FIG. 3. This midpoint position 202M assumed by the substrate 202 is shown as a solid line rectangle in FIG. 3. The substrate 202 subjected to the oscillating motion sweeps through an angular range, denoted a, separating two extreme positions 202A and 202H. These extreme positions 202A and 202H taken by the substrate 202 are shown by dashed line rectangles in FIG. 3.

According to another embodiment, the deposition of material, in the liquid state, is carried out on an initially immobile substrate 202. The substrate 202 is then subjected to an oscillating motion after the material to be deposited is poured thereon.

The oscillating movement can be likened to a succession of pivots of the substrate 202 about the axis 39, alternately in a clockwise and counterclockwise direction. Arbitrarily being placed in a situation where the substrate 202 is initially in its middle position 202M, the oscillating movement, for the substrate 202 seen from above in FIG. 3, can be considered to consist of repeating the following succession of steps:
counterclockwise pivoting at an angle, noted θ, to reach the extreme position 202A;
pivoting clockwise through an angle −θ to regain the middle position 202M;
continuing to rotate clockwise through an angle, noted β, to reach the extreme position 202H; and
pivoting counterclockwise through an angle −β to regain the middle position 202M.

In the example shown in FIG. 3, the angular range α is equal to the sum of the angles θ and β. This angular range α is preferably centered in relation to the middle position 202M. In other words, the angles θ and β are preferably equal, to the nearest value. The position 202M corresponds to a position taken by the substrate 202 at rest, for example, i.e. before the oscillatory motion begins or after the oscillatory motion has ceased.

The oscillatory motion amplitude to which the substrate 202 is subjected is equal to the angular range α. This angular range α is between about 5° and about 180°, preferably between 20° and 120°, more preferably between 30° and 90°.

In the extreme position 202A or 202H, the substrate is momentarily immobile. To move from one extreme position to the other, the substrate 202 is therefore subjected to an angular acceleration. This angular acceleration is based on a time taken by the substrate 202 to reach a pivoting speed about the axis 39. In the case of a deposition equipment 30 as discussed in relation to FIG. 2, this pivoting speed is parameterized in the control unit 37, for example.

The angular acceleration to which the substrate 202 is subjected as it moves from one extreme position to another is between about 0.1 rad·s⁻² and about 3,000 rad·s-2, preferably between about 100 rad·s⁻² and about 2,000 rad·s⁻². This angular acceleration is, more preferably, about 2,000 rad·s⁻². The angular acceleration is, even more preferably, equal to 2,000 rad·s⁻².

When depositing on the surface of the substrate 202, for example on its upper surface 212 (FIG. 2), one or more drops of material to be deposited are dispensed near the center or middle of this surface 212. The center of the surface 212 corresponds to a location in FIG. 3 where the axis 39 crosses this surface 212. Under the effect of the oscillations of the substrate 202, the inventors have found that the material to be deposited thus forms a puddle that spreads over the surface 212.

Unlike the spin coating technique previously mentioned, the embodiment described in relation to FIG. 3 makes it possible to limit the loss of material. For a given material and viscosity, this loss of material is significantly lower than the loss of material obtained by the spin coating technique described in FIG. 1.

As a particular example of one embodiment, with a liquid nanocomposite material of the cobalt-polystyrene type, there is a loss of material of the order of 90% using the spin coating technique described in relation to FIG. 1. This loss of material is limited to less than 10%, in contrast to the technique described in relation to FIG. 3.

Another advantage of this embodiment is that it allows uniform and homogeneous deposits to be achieved not only on circular-shaped substrates, but also on polygonal-shaped substrates such as rectangular or square-shaped substrates. In the case of rectangular substrates, good results are obtained when the substrate has an aspect ratio such that the length of the substrate is less than twice its width, viewed from above.

The embodiment set out in relation to FIG. 3 is, moreover, well suited to deposits of liquid nanocomposite materials, i.e., materials comprising a liquid polymer resin, obtained by dissolving a polymer in a solvent, for example, in which nanoparticles are dispersed. In particular, the inventors have found that this embodiment gives good results for magnetic nanocomposite materials, i.e. materials comprising a polymer resin loaded with magnetic nanoparticles. In particular, the composition remains homogeneous in proportion of magnetic nanoparticles.

The embodiment described in relation to FIG. 3 is also transposable by the person skilled the art to other types of liquid nanocomposite materials, in particular materials comprising dielectric nanoparticles dispersed in a polymer resin.

FIG. 4 shows, schematically, a side and cross-sectional view of one embodiment of a layer 216 deposited by the coating method disclosed in relation to FIG. 3.

According to this embodiment, the layer 216 deposited on the top surface 212 of the substrate 202 has a substantially constant thickness, denoted E. In particular, the thickness E of the layer 216 is approximately the same whether in regions near the axis 39 or in regions away from the axis 39.

Upon deposition of a liquid nanocomposite resin containing magnetic nanoparticles, the inventors have found that these magnetic nanoparticles (shown as dots in FIG. 4) are homogeneously distributed in the layer 216. The inventors further found that the layer 216 had a magnetic nanoparticle concentration approximately equal to the magnetic nanoparticle concentration in the material prior to deposition.

These advantages are retained when the liquid material contains other types of nanoparticles in addition to magnetic nanoparticles.

The implementation of the coating method described in relation to FIG. 3 makes it possible to produce a layer 216 with a thickness E of between about 10 μm and about 1 mm, preferably between 10 μm and 500 μm, more preferably between 20 μm and 300 μm. This coating method thus makes it possible to produce layers 216 that are much thicker than the layers 12 deposited by spin coating as shown in relation to FIG. 1.

The thickness E of the layer 216 depends on the amplitude of the oscillatory motion. The greater the angular range α of the oscillatory motion imposed on the substrate 202, the smaller the thickness E of the layer 216. Conversely, the smaller the angular range α, the greater the thickness E of the layer 216. In other words, the thickness E of the layer 216 can be controlled by adjusting the angular range α of the oscillations.

The substrate 202 on which the layer 216 is deposited is made of a semiconductor material, ceramic material, glass material, plastic material, or metal. Preferably, the substrate 202 is made of silicon. In some embodiments, the substrate 202 is a ceramic substrate of an electronic device 2 having at least one conductive element (not shown) on its top surface 212 for forming a capacitance or an inductive winding (21) for forming, for example, an inductor, a filter, a transmission line, an antenna, etc. This element or winding 21 of the device 2 is thus encapsulated by the layer 216 covering the substrate 202.

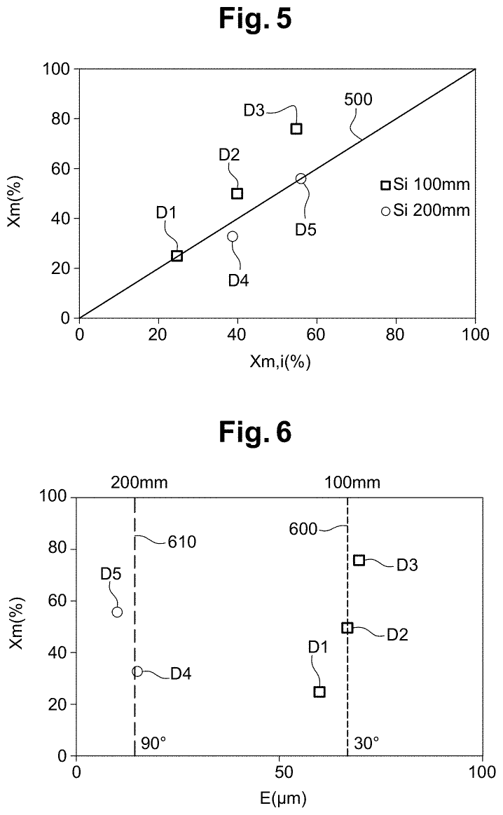

FIG. 5 is a characteristic graph of layers obtained by implementing the method set out in relation to FIG. 3.

By way of example, the coating method set out in relation to FIG. 3 will hereafter be considered implemented to deposit magnetic nanocomposite materials. These materials are obtained from a stock solution comprising a homogeneous solution consisting of a solvent in which a polymer is completely dissolved.

In the case of a magnetic nanocomposite material, a solution, called the “starting solution”, is prepared from a heterogeneous mixture between the polymer stock solution and a colloidal solution of magnetic nanoparticles held in suspension. The nanoparticles are surrounded by ligands or, for example, surfactants or by a polymer shell to delay their sedimentation. Depending on the case, the starting solution comprises a single solvent or several solvents, such as one solvent for the polymer solution and another solvent for the colloidal solution of nanoparticles. Preference is given to the use of solvents in which the colloidal suspension of nanoparticles does not sediment too quickly and does not evaporate too quickly, such as the solvent called PGMEA (propylene glycol methyl ether acetate).

Before the deposition is carried out, an ultrasonic probe is immersed in the starting solution for a few minutes so that it is sufficiently uniform, i.e. without significant sediment and/or supernatants. In particular, it is ensured that the starting solution is characterized by a sufficient sedimentation time, preferably longer than 10 minutes and advantageously longer than 1 hour. This sedimentation time is such that it is possible to deposit a drop of starting solution in the center of a substrate and to produce a layer or film in a few seconds, under the action of the oscillating movement imparted to this substrate and advantageously to repeat the operation on several substrates.

In the spin coating technique described in relation to FIG. 1, one generally works at constant viscosity (i.e., with a fixed polymer quantity) while varying the quantity or concentration or content or proportion of nanoparticles in the starting solution. For the implementation of the coating method on a substrate subjected to an oscillating motion, one works at constant load, i.e. at constant nanoparticle concentration, varying the viscosity by adjusting the amount of polymer contained in the starting solution. Since the weighing of the nanoparticles is significantly more critical than that of the polymer granules, it is advantageous to perform it only once, to obtain fewer losses as well as better accuracy.

In practice, in order to carry out deposits on substrates subjected to an oscillating movement, starting solutions, or “test” solutions, are thus prepared from:
a first solution, called the “stock” solution, containing a given concentration of nanoparticles;
several second solutions, containing a variable concentration of polymer.

The polymer concentration in the test solution chosen to carry out the deposition is then adjusted based on the layer thickness desired and the dimensions of the surface of the substrate receiving this deposit.

FIG. 5 takes five separate deposits as examples, made using the coating method set out in relation to FIG. 3. More precisely:
a first deposit, noted D1, on a 100 mm diameter thermally oxidized silicon wafer, from a first test solution formula;
a second deposit, noted D2, on a thermally oxidized silicon wafer of 100 mm diameter, from a second test solution formula;
a third deposit, noted D3, on a 100 mm diameter thermally oxidized silicon wafer, from a third test solution formula;
a fourth deposit, D4, on a 200 mm diameter thermally oxidized silicon wafer from the second test solution formula; and
a fifth deposit, denoted D5, on a 200 mm diameter thermally oxidized silicon wafer from the third test solution formula.

The first test solution formula contains:
5 mL of a polystyrene (PS) stock solution concentrated to about 30% by volume, obtained by diluting about 15 g of PS in about 50 mL of PGMEA; and
5 mL of a colloidal solution containing 500 mg of cobalt nanoparticles (NPs) dispersed in 5 mL of PGMEA. This results in a first test solution theoretically consisting of 80% PS and 20% NPs, on a dry basis and by mass.

The second test solution formula contains:
5 mL of a polystyrene (PS) stock solution concentrated to about 17% by volume, obtained by diluting about 5.25 g of PS in about 35 mL of PGMEA; and
5 mL of a colloidal solution containing 500 mg of cobalt nanoparticles (NPs) dispersed in 5 mL of PGMEA. This results in a second test solution theoretically consisting of 67% PS and 33% NPs, on a dry basis and by mass.

The third test solution formula contains:
5 mL of a polystyrene (PS) stock solution concentrated to about 7% by volume, obtained by diluting about 1.5 g of PS in about 20 mL of PGMEA; and
5 mL of a colloidal solution containing 500 mg of cobalt nanoparticles (NPs) dispersed in 5 mL of PGMEA. This results in a third test solution theoretically consisting of 44% PS and 56% NPs, on a dry basis and by mass.

In this example, the three test solutions are thus prepared from the same stock solution containing the cobalt nanoparticles and from three solutions with different polystyrene concentrations.

For each deposit D1 to D5, the angular range of oscillation a (FIG. 3) is adjusted so as to obtain a uniform spreading of the solution to the edges of the substrate, while minimizing material ejection. This thus maximizes the thickness of the deposited layer for a given volume of material.

In the example considered, for deposits D1 to D3, i.e. for deposits made on silicon wafers with a diameter of 100 mm, the following operating conditions are used
volume of test solution deposited: 4 mL;
oscillation angle range: 30°; and
oscillation time: 10 s.

Still in the example considered, for the deposits D4 and D5, i.e. for the deposits carried out on silicon wafers with a diameter of 200 mm, the following operating conditions are used:
volume of test solution deposited: 10 mL;
oscillation angle range: 90°; and
oscillation time: 10 s.

Since the test solutions used in this example are all three relatively fluid, the inventors found that the deposited layers are only minimally sensitive to differences in viscosity affecting these test solutions. In contrast, the inventors have found that the deposited layers may be more significantly dependent on surface properties of the substrate or a surface condition of the substrate. For example, a hydrophobic surface tends to result in a thick deposit but with holes. A hydrophilic surface, on the other hand, tends to result in a deposit with no holes, but with less thickness than a hydrophobic surface.

FIG. 5 shows a relationship, on the ordinate, between the final mass fraction of nanoparticles in the dry layer obtained after deposition and evaporation of the solvent, noted Xm and expressed in percentage (%) and, on the abscissa, the initial mass fraction of nanoparticles in the deposited solution, noted Xm,i and expressed in percentage (%).

This relationship is shown, in FIG. 5, by square-shaped points for the deposits D1, D2 and D3 carried out on 100 mm substrates (Si 100 mm) and by round-shaped points for the deposits D4 and D5 carried out on 200 mm substrates (Si 200 mm).

In FIG. 5, it can be seen that for each deposit D1 to D5, the mass fraction Xm is approximately equal to the mass fraction Xm,i. This is shown by the fact that the points representing the deposits D1 to D5 are close to a curve 500, for which the nanoparticle concentrations in the solution before deposition and in the layer after deposition are identical. In other words, the nanoparticle concentration in the nanocomposite films obtained after the deposits D1 to D5 is substantially the same as the nanoparticle concentration in the initial solution.

One advantage of the embodiment disclosed in relation to FIG. 3 is therefore that it allows for the nanoparticle concentration in the layer obtained after deposition to be predicted easily, since this concentration is substantially equal to that in the initial solution.

FIG. 6 is another characteristic graph of layers obtained by the embodiment described in relation to FIG. 3.

As an example, the five deposits D1 to D5 are still considered as shown in relation to FIG. 5. FIG. 6 shows a relationship, on the ordinate, between the final mass fraction of nanoparticles in the polymer of the layer obtained after deposition, noted Xm and expressed in a percentage (%) and, on the abscissa, the thickness of the deposition made, noted E and expressed in micrometers (μm).

For the deposits D1, D2 and D3, carried out on 100 mm substrates, it can be seen in FIG. 6 that the thickness E of the deposited layer is substantially the same whatever the nanoparticle concentration. This thickness E depends on the angular range of oscillation, here 30° for the deposits D1 to D3. This angular range of 30° gives a layer thickness E of about 70 μm for 4 mL of deposited solution.

Similarly, for deposits D4 and D5, carried out on 200 mm substrates, it can be seen in FIG. 6 that the thickness E of the deposited layer is substantially the same regardless of the nanoparticle concentration. This thickness E depends on the angular range of oscillation, here 90° for the deposits D4 and D5. This 90° angular range gives a layer thickness E of about 20 μm for 10 mL of deposited solution.

In other words, for a given substrate size, there is an optimum relationship between the solution volume dispensed and the angular range to enable the material to be spread over the entire surface of the substrate while avoiding losses.

For a circular wafer with a diameter of 100 mm, a volume of 4 mL of dispensed solution and an angular range of 30° form the optimal torque, in this example, to obtain a maximum thickness E (here, about 70 μm) without material loss. This optimal torque is shown in FIG. 6 by a first vertical line 600.

For a circular wafer with a diameter of 200 mm, a volume of 10 mL of dispensed solution and an angular range of 90° form the optimal torque, in this example, for obtaining a maximum thickness E (here, about 20 μm) without material loss. This optimal torque is shown in FIG. 6 by a second vertical line 610.

Once the optimal torque has been determined for a substrate of given size, it is then easy to vary the nanoparticle concentration in the layer obtained after deposition for the same layer thickness E. This, in FIG. 6, amounts to moving along lines 600 (in the example of a 100 mm diameter wafer) and 610 (in the example of a 200 mm diameter wafer).

The advantages previously discussed in relation to FIGS. 5 and 6 remain valid for non-circular shaped substrates, such as polygonal (rectangular or square) shaped substrates.

Compared to the spin coating technique set out in relation to FIG. 1, the embodiment described in relation to FIG. 3 thus makes it possible in particular:
to obtain thicker layers in a single deposit;
to predict the concentration of nanoparticles in the deposited layer more accurately;
to produce thick nanocomposite films (several tens of microns) on non-circular substrates such as on rectangular ceramic substrates.

The embodiment described in relation to FIG. 3 can be coupled with the spin coating technique. For example, a layer can be deposited first on a substrate that is subjected to an oscillating motion. Then, this substrate is rotated in order to “smoothen” the surface of the deposit before the film is completely dried. This results in a nanocomposite film with an improved surface finish as compared to a nanocomposite film obtained directly by the embodiment shown in relation to FIG. 3.

Various embodiments and variants have been described. Those skilled in the art will understand that certain features of these embodiments can be combined and other variants will readily occur to those skilled in the art. In particular, the angular range and acceleration of the oscillations to which the substrate is subjected may be adjusted as based on the characteristics (shape, surface roughness, etc.) of this substrate.

Finally, the practical implementation of the embodiments and variants described herein is within the capabilities of those skilled in the art based on the functional description provided hereinabove.

1. A method for depositing a layer of a composite material, comprising the step of pouring said material, in the liquid state, onto the surface of a substrate subjected to an oscillating movement, taking place in a plane substantially parallel to the surface of the substrate on which the deposition of the layer is performed and around a rotational axis perpendicular to the substrate, wherein:
the material comprises a liquid polymer having nanoparticles dispersed therein; and
the layer has a thickness of between about 10 μm and about 1 mm, preferably between 10 μm and 500 μm, more preferably between 20 μm and 300 μm.

2. The method according to claim 1, wherein said substrate is subjected to oscillatory motion during pouring.

3. The method according to claim 1, wherein said substrate is subjected to the oscillating motion after pouring.

4. The method according to claim 1, wherein the nanoparticles are magnetic nanoparticles.

5. The method according to claim 1, wherein the thickness of the layer is based on the amount of material poured.

6. The method according to claim 1, wherein the uniformity of the thickness of the layer across the surface of the substrate is based on the amplitude of the oscillating motion.

7. The method according to claim 1, wherein the oscillatory motion amplitude is between about 5° and about 180°, preferably between 20° and 120°, more preferably between 30° and 90°.

8. The method according to claim 1, wherein the oscillating motion is performed at an acceleration of between about 0.1 rad·s⁻² and about 3,000 rad·s⁻², preferably between about 100 rad·s⁻² and about 2,000 rad·s⁻², more preferably about equal to 2,000 rad·s⁻².

9. The method according to claim 1, wherein the substrate is circular in shape.

10. The method according to claim 1, wherein the substrate is polygonal in shape, preferably rectangular or square in shape.

11. The method according to claim, wherein the substrate is made of a semiconductor, ceramic, glass, plastic material or metal, preferably silicon.

12. The method according to claim 1, wherein the oscillating motion is imposed on the substrate by spin coating equipment (30).

13. The method according to claim 1, wherein the substrate carries at least one conductive element for forming a capacitance or an inductive winding for forming an inductance, transmission line or antenna, said element or winding being encapsulated by the layer covering the substrate.

14. An electronic device comprising at least one layer deposited by the method of claim 1.
